(19) United States
(12) Patent Application Publication
(10) Pub. No.: US 2014/0329965 A1
(43) Pub. Date: Nov. 6, 2014

(54) PROCESS FOR PREPARING PLASTICS WITH IMPROVED HYDROLYSIS STABILITY, THE PLASTICS PREPARED FROM THE SAME AND USES THEREOF

(71) Applicants: Guobin Sun, Shanghai (CN); Zhiping Zhou, Shanghai (CN); Jingui Shi, Shanghai (CN); Yuedong Zhang, Shanghai (CN)

(72) Inventors: Guobin Sun, Shanghai (CN); Zhiping Zhou, Shanghai (CN); Jingui Shi, Shanghai (CN); Yuedong Zhang, Shanghai (CN)

(73) Assignee: Bayer Intellectual Property GmbH, Monheim (DE)

(21) Appl. No.: 14/241,159

(22) PCT Filed: Aug. 27, 2012
(86) PCT No.: PCT/EP2012/066590

§ 371 Date: May 27, 2014

(30) Foreign Application Priority Data
Aug. 29, 2011 (CN) 201110251384.0

(51) Int. Cl. C08K 3/16

(52) U.S. Cl. CPC C08K 3/16
USPC 524/779

(57) ABSTRACT

The present invention relates to a process for preparing plastics with improved hydrolysis stability, comprising a step of adding 0.05-5 wt. % perchlorate salt which is based on 100 wt. % of the plastics, as a raw material to prepare the plastics. The present invention also relates to the plastics prepared from the process and use thereof.

### FIELD OF THE INVENTION

The present invention relates to the field of plastics, particularly to processes for preparing plastic materials with improved hydrolysis stability and to plastic materials with improved hydrolysis stability and uses thereof

### BACKGROUND OF THE INVENTION

A variety of widely used high performance plastics, such as polyester, polycarbonate, polyurethanes, etc., are prepared from polymeric materials that comprise hydrolysable chemical bonds. A problem with these materials is that the hydrolysable bonds within their structure, such as the chemical bonds formed by the condensation of acids and alcohols, are hydrolyzed by the unavoidable exposure to moisture or direct water contact during use, thus leading to the cleavage of these hydrolysable bonds and the physical properties loss of these kind of materials gradually or even completely. Therefore, it has always been a research topic of material science to improve hydrolysis resistance of these hydrolysable chemical bond-containing materials.

There are two kinds of approaches to improve hydrolysis resistance of these plastic materials. One is to optimize molecular structure of the polymer chains in these materials so as to improve hydrophobicity or steric hindrance of the polymer chains. An improved hydrophobic environment will give water molecules less access to the polymer chain, therefore reducing the possibility of nucleophilic attack by water molecules. Similarly, enhanced steric hindrance would also prohibit water molecules from attacking the polymer chain. By these means, hydrolysis resistance of the polymer chain, thus the materials, is improved. For example, WO 2006097507A1 discloses that plastics with 2-methyl-1,3-propylene glycol as the monomer unit within the polymer chain show satisfactory hydrolysis resistance. WO 2007137105A1 also discloses that polymers with 1,3-cyclohexane dimethanol and 1,3-cyclohexane dimethanol as the monomer unit in the polymer chain, have improved hydrolysis resistance.

Another approach is to add a certain amount of anti-hydrolysis additive to the plastics to improve their hydrolysis resistance. For example, GB 1205257A discloses that alkylene carbonates can be effective additives to improve hydrolysis resistance of polyurethanes. Similarly, alkylene carbonates are also effective anti-hydrolysis additives for polyester plastics (U.S. Pat. No. 3,657,191, 5,563,209 and 6,528,161). U.S. Pat. No. 6,737,471B2 discloses that an ester of (mono)carboxylic acid is an effective anti-hydrolysis additive for polyurethanes as long as the (first) dissociation constant (pKa) of the corresponding carboxylic acid is between 0.5 and 4.0. GB 986200A discloses several kinds of high performance carbodiimides additives which can significantly improve hydrolysis resistance of polyurethanes. GB 1204866 discloses that carbodiimide can work with alkoxy hydroxylbenzophenone synergisticly to improve hydrolysis resistance of polyurethane. U.S. Pat. No. 6,169,157B1 discloses that the anti-hydrolysis performance of polyurethanes comprising carbodiimides as an additive can be further improved by adding lactone in the polyurethane's preparation process. U.S. Pat. No. 3,852,101 discloses that carbodiimides are also high performance anti-hydrolysis additives for polyester plastics. However, production of these carbodiimide type additives involves complex processes leading to high cost of these additives; and the operation procedure of these carbodiimides is complicated. Therefore, a simple process with high performance is in great demand to improve hydrolysis resistance of these plastic materials.

### SUMMARY OF THE INVENTION

The present invention provides a novel process for improving hydrolysis resistance of plastics.

In one aspect, the present invention provides a process to prepare plastic materials with improved hydrolysis resistance. The process comprises adding 0.05-5 wt. % perchlorate salt which is based on 100 wt. % of the plastics, as a raw material to prepare the plastics which contain polymeric chains comprising hydrolysable chemical bonds. In a preferred embodiment of the present invention, said hydrolysable chemical bonds comprise ester bonds. Preferably, the ester bonds comprise carbonate bonds, urethane bonds, alcohol-acid condensation ester bonds, or a combination thereof.

In another preferred embodiment of the present invention, said plastics include polyester, polycarbonate, polyurethane, or a combination thereof.

In another preferred embodiment of the present invention, said perchlorate salt comprises perchlorate as anion and the corresponding counter cation is selected from the group consisting of metallic elements and ammonium. Preferably, said metallic elements are selected from the group consisting of alkali metals and alkaline earth metals. More preferably, said metallic elements are selected from lithium and sodium.

In another preferred embodiment of the present invention, said perchlorate salts are used in the form of anhydrous, hydrate or solution.

In another preferred embodiment of the present invention, the solvents of said perchlorate salt solution are selected from the group consisting of water and organic solvents. In another preferred embodiment of the present invention, said solvents comprise alcohols, esters, ethers, amides, sulfones or sulfoxides. In another preferred embodiment of the present invention, the amount of said solvents is 0.1-15 wt. %, based on 100 wt. % of the plastics.

In another preferred embodiment of the present invention, said polyurethane is the product prepared from raw components comprising isocyanates, a second polyol and the perchlorate salts, wherein the isocyanates comprise organic polyisocyanate and/or modified organic polyisocyanate or a combination thereof, or isocyanate terminated prepolymers produced with a first polyol; and the hydroxyl value of the first polyol and the second polyol is 20-280, and the functionality is 1-4.

Preferably, the first polyol is the same or different from the second polyol, and at least one of the first polyol and the second polyol comprises at least one polyester polyol.

In another aspect, the present invention relates to the use of the plastics with improved hydrolysis stability prepared according to the above process in foamed plastics, thermoplastic plastics, elastomers or microcellular elastomers, particular in preparing shoes.

In another aspect, the present invention provides a plastic material with improved hydrolysis stability, characterized in that the raw components of the plastics comprise 0.05-5 wt. % perchlorate salt, based on 100 wt. % of the plastics.

In a preferred embodiment of the present invention, said plastics comprise polyester, polycarbonate, polyurethane, or a combination thereof.

In another preferred embodiment of the present invention, said plastics are polyurethane.

In another preferred embodiment of the present invention, said perchlorate salt comprises perchlorate as anion and the corresponding counter cation is selected from the group consisting of metallic elements and ammonium. Preferably, said metallic elements are selected from the group consisting of alkali metals and alkaline earth metals. More preferably, said metallic elements are selected from the group consisting of lithium and sodium.

In another aspect, the present invention relates to the use of said plastics with improved hydrolysis stability in foamed plastics, thermoplastic plastics, elastomers or microcellular elastomers, particularly in preparing shoes.

### DETAILED DESCRIPTION OF THE INVENTION

The inventors, after wide and deep research, surprisingly discovered that perchlorate salts are very effective additives for improving hydrolysis resistance of plastic materials. Without being limited by theory, a possible mechanism is that the cations of the perchlorate salts may have a weak coordination with the hydrolysable chemical bonds on the polymer chains of the plastics and form a steric protection layer around hydrolysable bonds, thus reducing the nucleophilic attack probability by water molecules and improving the hydrolysis resistance of plastics. These perchlorate salts have been found to be effective to improve hydrolysis resistance of plastics containing hydrolysable bonds without any damage to their physical properties and processability. Based on these findings, the present invention can be achieved.

Polyurethanes

The polyurethane prepared according to processes described in the present invention comprises the following raw materials:

a) organic polyisocyanates and/or modified organic polyisocyanates, preferably organic diisocyanate;

b) at least one second polyol, preferably polyester polyol, with OH number of 20-280, preferably 28 to 150, and with a functionality of 1 to 4, preferably 1.8-2.5;

c) perchlorate salts,

d) optionally a catalyst,

e) optionally a chain extender, wherein the average molecular weight of the chain extender is equal to or less than 800, and

f) optionally blowing agents and surfactants.

Component a)

Said component a) polyisocyanates are described by the formula, R(NCO), wherein n=2-4, preferably 2, and R represents an aliphatic hydrocarbon radical containing 2-18 carbon atoms, a cycloaliphatic hydrocarbon radical containing 3-18 carbon atoms, an aromatic hydrocarbon radical containing 6-15 carbon atoms, or an araliphatic hydrocarbon radical containing 8-15 carbon atoms.

Examples include, but are not limited to, ethylene diisocyanate, 1,4-tetramethylene diisocyanate, 1,6-hexamethylene diisocyanate (HDI), 1,12-dodecane diisocyanate, cyclobutane-1,3-diisocyanate, cyclohexane 1,3- and 1,4-diisocyanates and any mixtures of these two isomeric compounds, 1-isocyanato-3,3,5-trimethyl-5-isocyanatomethyl-cyclohexane, 2,4- and 2,6-hexahydrotoluene diisocyanates and any mixtures of these two isomeric compounds, hexahydro-1,3- and 1,4-phenylene diisocyanate, perhydro-2,4- and 4,4′-diphenylmethane diisocyanate, 1,3-and 1,4-phenylene diisocyanate, 1,4-durol diisocyanate, 4,4′-stilbene diisocyanate, 3,3′-dimethyl-4,4′-biphenylene diisocyanate, toluene 2,4- and 2,6-diisocyanates (TDI) and any mixtures of these two isomeric compounds, diphenylmethane-2,4′-, 2,2′- and 4,4′-diisocyanates (MDI), and naphthylene-1,5-diisocyanate (NDI).

Said polyisocyanates in component a) also include the modifications of the above mentioned isocyanates containing carbodiimide, uretoneimine, allophanate or isocyanurate structures.

Said component a) can also be isocyanate-terminated prepolymers produced by reacting an excess amount of polyisocyanates with the first polyol which preferably is polyester polyol.

Component b)

Suitable polyester polyols can be used as component b) which may be produced from the reaction of organic dicarboxylic acids or dicarboxylic acid anhydrides with polyhydric alcohols. Suitable dicarboxylic acids are preferably aliphatic carboxylic acids containing 2 to 12 carbon atoms, for example, succinic acid, malonic acid, glutaric acid, adipic acid, suberic acid, azelaic acid, sebacic acid, decane-dicarboxylic acid, maleic acid, fumaric acid, phthalic acid, isophthalic acid, or terephthalic acid. The dicarboxylic acids can be used both individually and as an admixture with each other. Suitable anhydrides are, for example, phthalic anhydride, terachlorophthalic anhydride, or maleic anhydride. Representative polyhydric alcohols include ethanediol, diethylene glycol, 1,2- and 1,3-propanediols, dipropylene glycol, 1,3-methylpropanediol, 1,4-butanediol, 1,5-pentanediol, 1,6-hexanediol, neopentyl glycol, 1,10-decanediol, glycerol, trimethylol-propane, or mixtures of at least two of these diols. Polyester polyols of lactones, for example, c-caprolactone, can also be used.

In addition, polycarbonate polyols also can be used as component b), which may be produced from the reaction of diols such as 1,2- and 1,3-propanediols, 1,4-butanediol, 1,5-pentanediol, 1,6-hexanediol, diethylene glycol, trioxyethylene glycol, with dialkyl or diaryl carbonates, eg. diphenyl carbonate, or phosgene. Suitable polyether polyols which can be used as component b) are produced by known process, e.g. in the reaction of alkene oxides with polyhydric alcohol starters in the presence catalysts such as alkali hydroxides, alkali alkoxides, antimony pentachloride, boron fluoride etherate or metal coordinate catalyst. Examples of suitable alkene oxides include tetrahydrofuran, ethylene oxide, 1,2-propylene oxide, 1,2- and 2,3-butylene oxide, or styrene oxide. The polyether polyols preferably have primary OH terminal groups, and secondary OH groups may also exist. Suitable starter molecules may be selected from polyhydric compounds, such as, water, ethylene glycol, 1,2- and 1,3-propanediols, 1,4-butanediol, diethylene glycol, or trimethylol-propane.

At least one of the first polyol and the second polyol comprises at least one polyester or polycarbonate polyol.

Component c)

Said component c) are perchlorate salts with perchlorate as the anion and the counter cations are mainly selected from metallic elements, preferably selected from the group consisting of alkali and alkaline earth elements, and most preferably lithium and sodium. The perchlorate salts can be used optionally in the form of anhydrous, hydrate or solution. The salts can be used individually or as an admixture with each other. Typical examples of the salts include but are not limited to beryllium perchlorate, lithium perchlorate, sodium perchlorate, magnesium perchlorate, calcium perchlorate, strontium perchlorate, barium perchlorate, and ammonium perchlorate, etc. The component c) is used in an amount of 0.05 to 5% by weight, preferably 0.5 to 2.0% by weight, based on 100% by weight of the final product, e.g. polyurethanes.

In the process of present invention for preparing polyurethane, the perchlorate salts can be dispersed into a) polyisocyanate, b) polyol or other components such as chain extenders, and then mixed with other component through mechanical stirring or other physical methods.

Said component c) is preferably in the form of solution by dissolving the perchlorate salts in solvent first, and then be dispersed into a) polyisocyanate, b) polyol or other components. The solvents which is used to dissolve the component c) may help the perchlorate well disperse into the isocyanates (component a)) and/or the second polyol (component b)).

Examples of suitable solvents include water and compounds such as ether, ketone, ester, alcohol, amide, carbonate, sulfoxide, sulfone, substituted alkane, aromatic derivatives, heterocyclics or polymers, etc. Typical examples, for example, are tetrahydrofuran, acetone, acetonitrile, N,N-Dimethylacetamide, dimethyl sulfoxide, ethyl acetate, ethylene glycol, pyrrolidone, hexamethylphosphoryl triamide, N-methyl-2-pyrrolidone, 1,3-dimethyl-2-imidazolidinone, N,N-dimethylformamide, ionic liquids, polyether, polyacrylate, polysiloxane, or their substituted derivatives, etc. They can be used both individually and as an admixture with each other. The solvent to dissolve the salt is used in the amount of 0.1 to 15% by weight, preferably 1 to 10% by weight, based on 100% by weight of the final product, e.g. polyurethanes.

Component d)

Amine catalysts are usually used as said component d), which include but are not limited to tertiary amines such as triethylamine, tributylamine, N-methylmorpholine, N-ethylmorpholine, N,N,N′,N′-tetramethyl-ethylenedi-amine, pentamethyldi-ethylene-triamine, N,N-methylbenzylamine, and N,N-dimethylbenzylamine. Organo-metallic compounds, particularly organo-tin compounds, may be used as additional catalysts, such as tin(II) acetate, tin(II) octoate, tin(II) ethylhexonate, tin(II) laurate, dibutyltin oxide, dibutyltin dichloride, dibutyltin diacetate, dibutyltin dilaurate, dibutyltin maleate, or dioctyltin diacetate. The catalysts are used in the amount of 0.001 to 5% by weight, preferably 0.01 to 1% by weight, based on 100% by weight of the final product, e.g. polyurethanes.

Component e)

Said components e), i.e. chain extenders, typically have molecular weights less than 800, preferably from 18 to 400, such as alkanediols, dialkylene glycols, and polyalkylene polyols. The examples are ethanediol, 1,3-propanediol, 1,4-butanediol, 1,6-hexanediol, 1,7-heptanediol, 1,8-octanediol, 1,9-nonanediol, 1,10-decanediol, diethylene glycol, dipropylene glycol, or polyoxyalkylene glycols. Other suitable substances are branched chain and unsaturated alkanediols such as 1,2-propanediol, 2-methyl-1,3-propanediol, 2,2-dimethyl-1,3-propanediol, 2-butyl-2-ethyl-1,3-propanediol, 2-butene-1,4-diol and 2-butyne-1,4-diol, alkanolamines and N-alkyldialkanolamines such as ethanol-amine, 2-aminopropan-ol and 3-amino-2,2-dimethylpropanol, N-methyl and N-ethyl-diethanolamines, as well (cyclo)aliphatic and aromatic amines, eg. 1,2-ethylenediamine, 1,3-propylenediamine, 1,4-butylenediamine, 1,6-hexamethylenediamine, isophoronediamine, 1,4-cyclohexamethylenediamine, N,N′-diethylphenylene-diamine, or 2,4- and 2,6-diaminotoluene. The chain extenders are used in the amount of 1 to 20% by weight, based on 100% by weight of the final product, e.g. polyurethanes.

Component f)

Blowing agents and surfactants are optionally employed in the polyurethane production. Suitable blowing agents include water, halohydrocarbons, hydrocarbons and gases. Examples of halohydrocarbons are monochlorodifuloromethane, dichloromonofluoromethane, dichlorofluoromethane, and trichlorofluromethane. Examples of hydrocarbons include butane, pentane, cyclopentane, hexane, cyclohexane, or heptane. Blowing gases include, but not limited to, air, CO2, and N2. Suitable surfactants are selected preferably from but not limited to polyoxyalkylene derivatives of siloxane, in an amount of 0.01 to 2.5% by weight, based on 100% by weight of the final product, e.g. polyurethanes.

Preparation of the Polyurethanes

Polyurethanes in the present invention are prepared as following: mixing the components a) to c) in the presence of optional catalysts d) and optionally blowing agents and surfactants f), at 20 to 80° C., preferably 30 to 60° C.; injecting the above mixture into a mold for 2 to 15 minutes, and demoulding to obtained a polyurethane product. For detailed procedures, please refer to handbook (Kunststoff Handbuch, Volume VII, Polyurethanes, 1994 by Dr. G. Oertel, Carl-Hanser-Verlag, Munich). The molds described herein are those frequently used in the existing technology to prepare polyurethanes, in which the reaction system can react to provide the polyurethanes of the present invention.

The NCO Index of said reaction can be optimized by the well-known methods in the prior art.

The NCO Index of said reaction is preferably but not limited to 50-160, particularly preferably from 80-120. The NCO Index X(%) is defined as:

$$X = \frac{\begin{matrix}the mole number of isocyanate \\ group ( N C O group ) in component A\end{matrix}}{[ \begin{matrix}the mole number of isocyanate \\ reactive group comprised in component B\end{matrix} ]} \times 100$$

In the process of preparing the polyurethanes, the equipment to mix all the reaction components can be high-pressure or low-pressure mixing-head machine, preferably low-pressure mixing-head machine. The mixing process can be a two-component mixing or multi-component mixing. The polyurethane molding technology and equipment are those well-known in related fields. For details, please refer to “Polyurethanes Chemistry and Technology” (Saunders I-I and Frisch K C, Part II. 4th print. New York: Interscience Publ., Wiley & Sons, 1967) and “Polyurethane handbook: chemistry, raw materials, processing, application, properties” (Günter Oertel and Lothar Abele, 2nd edition, Hanser Gardner Publ., 1993), etc.

According to one embodiment of the present invention, said polyurethane was prepared from the components comprising:

i) isocyanate-terminated prepolymer, which is the reaction product of polyisocyanate and first polyol;

ii) a second polyol;

iii) perchlorate salts;

iv) catalysts; and

v) a chain extender with an average molecular weight of no less than 800;

wherein said first polyol and/or second polyol comprise at least one polyester polyols prepared from the condensation of adipic acid with diol and/or triol;

The reaction components may further comprise blowing agent and/or surfactant;

Said second polyol has average molecular weight from 1000 to 10000, with functionality from 1 to 5, preferably 1.5-3;

In said second polyol, the polyester polyol prepared from the condensation of adipic acid with diol and/or triol has an amount of 5-100 wt. %, based on 100 wt. % of the second polyol;

Said second polyol comprises polyester polyol, polyether polyol, polycarbonate polyol, or the combination thereof.

The polyurethane materials prepared from the process of the present invention have improved hydrolysis resistance.

Uses of Polyurethanes

Said polyurethanes in the embodiments of the present invention has various uses, including foamed plastics, thermoplastic plastics, elastomers or microcellular elastomers, the use in shoe making industry, such as shoes materials making, is also included. The related molding technology and equipment are those well-known in related fields. For details, please refer to Kunststoff I-Iandbuch, Volume VII, polyurethanes, 1994, Dr. G. Oertel, Carl-Hanser-Verlag, Munich.

Polyester and polycarbonate

The polyester and polycarbonate prepared according to the process of the present invention are plastics made from polymers comprising ester bonds derived from carboxylic acid and alcohol condensation reaction and carbonate bonds, respectively, characterized in that 0.05-5 wt. % perchlorate salt is added in the process, based on 100 wt. % of the plastics. The perchlorate salts can be dispersed into polyester and polycarbonate raw materials by mechanical mixing or other common physical ways, and then the resulted mixtures are processed by traditional approaches to get re-formed polyesters and polycarbonates with improved hydrolysis resistance of the present invention.

Preparation of Polyesters and Polycarbonates

Said polyesters and polycarbonates of the present invention are prepared by dispersing perchlorate salts into polyester and polycarbonate raw materials through mechanical mixing or other common physical ways, and followed by traditional re-forming process.

Uses of Polyesters and Polycarbonates

Said polyesters and polycarbonates with improved hydrolysis resistance prepared according to the process of the present invention have various uses, including foamed plastics, thermoplastic plastics, elastomers or microcellular elastomers, particular in shoe materials.

Advantages of the present invention are: Perchlorate salts can significantly improve hydrolysis resistance of the plastics prepared according to the process of the present invention at a lower cost compared with the existing technologies, and will not produce any unfavorable effects to their physical properties and processability.

### EXAMPLES

The present invention will be further described by combining the following examples. However, it should be understood that these examples are exemplary only, and not intend to limit the scope of the present invention. The following examples usually go through conventional conditions or those recommended by the manufacturers and all the percentages are by weight percentage unless otherwise specified.

The commercial agents used in the examples are listed in the table below:

| | | |
|---|---|---|
| Bayflex ® 2003E | Adipate Polyester polyol, M_{w} 2000, OH | Purchased from |
| | value: 56 mg KOH/g | Bayer MaterialScience |
| Desmodur ® 0926 | Polyester-type Prepolymers terminated | Purchased from |
| | with isocyanates with NCO of 19.3% | Bayer MaterialScience |
| Dabco EG | Amine catalyst | Purchased from Air Products |
| Dabco DC 193 | Silicone surfactant | Purchased from Air Products |

In these examples, Desmodur® 0926 was used as component A (e.g. said component a)), and the mixture of Bayflex® 2003E and other components were used as component B (e.g. said component b). In the examples 1-7, sodium perchlorate was first dissolved into ethylene glycol, and then homogeneously mixed together with other components of B. In examples 8-10, lithium perchlorate was first dissolved into ethylene glycol, and then homogeneously mixed together with other components of B.

Component A was added into container 1 which was maintained at 45° C.; Component B was added into container 2 which was maintained at 45° C.

The NCO Index of said reaction can be optimized by the well-known methods in the existing technology.

### Comparison Example C1 and Examples E1-E7

Preparation process: All the raw materials in A and B were mixed through the mixing machine according to the predetermined ratio on Table 1, and then injected into the mold for reaction. The mold temperature was maintained at 50° C. and the NCO Index of said reaction can be optimized by the well-known methods in the existing technology. After certain reaction time, the mold was opened and the prepared samples were taken out for tests.

The physical property data of the sample before and after hydrolysis resistance tests are listed on Table 1. (The hydrolysis resistance test was conducted under the temperature of 70° C. and the relative humidity of 95%. At predetermined intervals, the samples were taken out and cut into a dumbbell shape for physical property measurement according to the standard ASTM D412).

TABLE 1
Polyurethanes prepared from sodium perchlorate and hydrolysis stability thereof

| Examples | | C1 | E1 | E2 | E3 | E4 | E5 | E6 | E7 |
|---|---|---|---|---|---|---|---|---|---|
| component A | Desmodur ® 0926 | 88 | 88* | 85* | 85* | 86* | 82* | 80* | 80* |
| | (wt. %) | | | | | | | | |
| component B | Bayflex ® 2003E | 100 | 100 | 100 | 100 | 100 | 100 | 100 | 100 |
| | (wt. %) | | | | | | | | |
| | ethylene glycol | 7 | 7 | 7 | 7 | 7 | 7 | 7 | 7 |
| | (wt. %) | | | | | | | | |
| | Dabco EG (wt. %) | 1.5 | 1.5 | 1.5 | 1.5 | 1.5 | 1.5 | 1.5 | 1.5 |
| | Dabco DC193 (wt. %) | 0.4 | 0.4 | 0.4 | 0.4 | 0.4 | 0.4 | 0.4 | 0.4 |
| | Water (wt. %) | 0.45 | 0.45 | 0.45 | 0.45 | 0.45 | 0.45 | 0.45 | 0.45 |
| | sodium perchlorate | 0 | 0.3 | 0.6 | 1.5 | 2.3 | 3 | 3.8 | 6 |
| physical | Density (kg/m³) | 550 | 550 | 550 | 550 | 550 | 550 | 550 | 550 |
| performance | tensile strength | 5.9/100 | 5.5/100 | 5.2/100 | 5.1/100 | 5.6/100 | 5.1/100 | 5.5/100 | 5.9/100 |
| | (MPa)/relative | | | | | | | | |
| | value(%) 0 week | | | | | | | | |
| | tensile strength | 5/84 | 5.3/95 | 5.2/100 | 5.1/100 | 5.3/96 | 5.1/100 | 5.2/95 | 5.5/94 |
| | (MPa)/relative | | | | | | | | |
| | value(%) 1 week | | | | | | | | |
| | tensile strength | 2.2/37 | 4.3/77 | 4.4/84 | 4.5/89 | 5.1/92 | 4.1/81 | 4.4/81 | 5.6/96 |
| | (MPa)/relative | | | | | | | | |
| | value(%) 2 week | | | | | | | | |

*the amounts were determined according to the NCO index of examples C1

As shown in table 1, compared with the comparison example C1, the tensile strength data of E1-E7 indicate that sodium perchlorate can be added into the polyurethane component as a raw material to significantly improve the hydrolysis stability of polyurethane. As an example, E4 contained 2.3 wt. % NaClO₄, based on 100 wt. % of the second polyol Bayflex® 2003E, and the tensile strength of the resulted polyurethane could still be maintained more than 90% after two-weeks of hydrolysis. The data in table 1 shows that the process provided by the present invention can increase hydrolysis stability of the polyurethane greatly, thus improving the lifetime of these plastics for various uses.

### Comparison Example C1 and Examples E8-E10

Preparation process: All the raw materials in A and B were mixed through the mixing machine according to the predetermined ratio on Table 1, and then injected into the mold for reaction. The mold temperature was maintained at 50° C. and the NCO Index of said reaction can be optimized by the well-known methods in the existing technology. After certain reaction time, the mold was opened and the prepared sample was taken out for tests.

The physical property data of the sample before and after hydrolysis resistance tests are listed in Table 2. (The hydrolysis resistance test was conducted under the temperature of 70° C. and the relative humidity of 95%. At predetermined intervals, samples were taken out and cut into a dumbbell shape for physical property measurement according to the standard ASTM D412).

TABLE 2
polyurethane prepared from lithium perchlorate and hydrolysis stability thereof

| Examples | | C1 | E8 | E9 | E10 |
|---|---|---|---|---|---|
| Component A | Desmodur ® 0926 | 88 | 89* | 87* | 86* |
| | (wt. %) | | | | |
| Component B | Bayflex ® 2003E | 100 | 100 | 100 | 100 |
| | (wt. %) | | | | |
| | ethylene glycol | 7 | 7 | 7 | 7 |
| | (wt. %) | | | | |
| | Dabco EG | 1.5 | 1.5 | 1.5 | 1.5 |
| | (wt. %) | | | | |
| | Dabco DC193 | 0.4 | 0.4 | 0.4 | 0.4 |
| | (wt. %) | | | | |
| | water | 0.45 | 0.45 | 0.45 | 0.45 |
| | (wt. %) | | | | |
| | lithium perchlorate | 0 | 0.6 | 1.5 | 2.3 |
| physical | Density | 550 | 550 | 550 | 550 |
| performance | (kg/m³) | | | | |
| | tensile strength | 5.9/100 | 5.0/100 | 5.4/100 | 5.3/100 |
| | (MPa)/relative | | | | |
| | value(%) | | | | |
| | 0 week | | | | |
| | tensile strength | 5.0/84 | 4.6/92 | 5.1/95 | 5.3/100 |
| | (MPa)/relative | | | | |
| | value(%) | | | | |
| | 1 week | | | | |
| | tensile strength | 2.2/37 | 3.4/68 | 4.9/90 | 4.8/90 |
| | (MPa)/relative | | | | |
| | value (%) | | | | |
| | 2 week | | | | |

*the amounts were determined according to the NCO index of examples C1

As shown in Table 2, examples E8-10, similar to examples E1-7, show that lithium perchlorate can also be added into the polyurethane component as a raw material to significantly improve the hydrolysis stability of polyurethane. Among these examples, E9-10 show that even with addition of as little as 1.5 wt. % LiClO₄, based on 100 wt. % of the second polyol Bayflex® 2003E, the tensile strength of the resulted polyurethane could still be maintained more than 90% after two-weeks of hydrolysis. The data in table 2 shows that the process provided by the present invention can increase hydrolysis stability of the polyurethane greatly, thus improving the lifetime of these plastics for various uses.

All the literatures mentioned in the present invention are incorporated into the present application by references, as each one being cited as a separate reference. Moreover, it should be understood that after reading the disclosure of the present application, a person skilled in the art can make many changes and modifications which may also fall into the scope of the present invention as claimed by the following claims.

1-22. (canceled)

23. A process for preparing a plastic with improved hydrolysis stability, comprising adding 0.05-5 wt. % perchlorate salt which is based on the 100 wt. % of the plastic, as a raw material for preparing the plastics, wherein the plastic comprises a polymer chain with hydrolysable chemical bonds.

24. The process according to claim 23, wherein the hydrolysable chemical bonds comprise ester bonds.

25. The process according to claim 23, wherein the ester bonds comprise carbonate bonds, urethane bonds, alcohol-acid condensation ester bonds or combinations thereof.

26. The process according to claim 23, wherein the plastic comprises polyester, polycarbonate, polyurethane or combinations thereof.

27. The process according to claim 23, wherein the perchlorate salt comprises perchlorate as anion, and a corresponding counter cation is selected from the group consisting of metallic elements and ammonium.

28. The process according to claim 27, wherein the metallic elements are selected from the group consisting of alkali metals and alkaline earth metals.

29. The process according to claim 28, wherein the metallic elements are selected from the group consisting of lithium and sodium.

30. The process according to claim 23, wherein the perchlorate salt is in the form of anhydrous, hydrate or solution.

31. The process according to claim 30, wherein the perchlorate salt solution comprises at least one solvent selected from the group consisting of water and organic solvents.

32. The process according to claim 31, wherein the organic solvents comprise alcohols, esters, ethers, amides, sulfones or sulfoxides.

33. The process according to claim 31, wherein the amount of the organic solvents is 0.1-15 wt. %, based on 100 wt. % of the plastic.

34. The process according to claim 26, wherein the polyurethane is the product prepared from raw components comprising: isocyanates, a second polyol and the perchlorate salts, wherein the isocyanates comprise organic polyisocyanate and/or modified organic polyisocyanate or a combination thereof, or isocyanate terminated prepolymers produced with a first polyol; wherein the hydroxyl value of the first polyol and the second polyol is 20-280, and the functionality is 1-4.

35. The process according to claim 34, wherein the first polyol is the same or different from the second polyol, and at least one of the first polyol and the second polyol comprises at least one polyester polyol.

36. A method comprising utilizing the plastic with improved hydrolysis stability prepared according to claim 23 in foamed plastics, thermoplastic plastics, elastomers or microcellular elastomers.

37. A method for preparing shoes comprising utilizing the plastics with improved hydrolysis stability prepared according to claim 23.

38. A plastic material with improved hydrolysis stability, wherein the plastic material is obtained from raw components comprising 0.05-5 wt. % perchlorate salt, based on 100 wt. % of the plastic material.

39. The plastic material according to claim 38, wherein the plastic material comprises polyester, polycarbonate, polyurethane or combinations thereof.

40. The plastic material according to claim 38, wherein the perchlorate salt comprises perchlorate as anion, and a corresponding counter cation is selected from the group consisting of metallic elements and ammonium.

41. The plastic material according to claim 40, wherein the metallic elements are selected from the group consisting of alkali metals and alkaline earth metals,

42. The plastic material according to claim 41, wherein the metallic elements are selected from the group consisting of lithium and sodium.

43. A method comprising utilizing the plastic material with improved hydrolysis stability according to claim 38 in foamed plastics, thermoplastic plastics, elastomers or microcellular elastomers.

44. A method for preparing shoes comprising utilizing the plastic material with improved hydrolysis stability according to claim 38.
